(19) United States
(12) Patent Application Publication
(10) Pub. No.: US 2014/0043377 A1
(43) Pub. Date: Feb. 13, 2014

(54) BACKLIGHT UNIT AND DISPLAY DEVICE

(71) Applicants: Shigenori Tanaka, Osaka-shi (JP); Ryoh Araki, Osaka-shi (JP); Yoshinobu Hirayama, Osaka-shi (JP); Toshihiro Yanagi, Osaka-shi (JP)

(72) Inventors: Shigenori Tanaka, Osaka-shi (JP); Ryoh Araki, Osaka-shi (JP); Yoshinobu Hirayama, Osaka-shi (JP); Toshihiro Yanagi, Osaka-shi (JP)

(73) Assignee: SHARP KABUSHIKI KAISHA, Osaka-shi, Osaka (JP)

(21) Appl. No.: 14/112,327

(22) PCT Filed: Apr. 16, 2012
(86) PCT No.: PCT/JP2012/060238

§ 371 Date: Oct. 17, 2013

(30) Foreign Application Priority Data
Apr. 22, 2011 (JP) 2011-096583

(51) Int. Cl. F21V 8/00; G09G 5/10

(52) U.S. Cl. CPC G02B 6/0091; G02B 6/0036; G09G 5/10
USPC 345/690; 362/613; 362/606

(57) ABSTRACT

A backlight unit (20) includes: light sources (4A, 4B); light guide members (2A, 2B), the light source (4A) being provided to a side surface of the light guide member (2A), the light source (4B) being provided to a side surface of the light guide member (2B), the light sources (4A, 4B) being provided across the light guide members (2A, 2b) in plane view; and an optical path changing member (1) for changing an optical path of light passing through the optical path changing member, the optical path changing member (1) having a light incidence surface (SUF1) for receiving light emitted directly from the light guide member (2A or 2B), and a light exit surface (SUF2) for emitting, directly to a display panel outside of the backlight unit (20), the light thus received via the light incidence surface (SUF1). This configuration makes it possible to large-size a backlight unit without the fear of display quality deterioration, and makes it possible for such a backlight unit to emit light with luminance directivity in different directions.

### TECHNICAL FIELD

The present invention relates to a backlight unit, and a display device including the backlight unit.

### BACKGROUND ART

Recently, thin, lightweight, and low-power consumption display devices, as typified in liquid crystal display devices, have been in widespread use. Such display devices are often incorporated in, for example, mobile phones, smart phones, or laptop personal computers. Further, it has been expected that Electronic papers, which are thinner display devices, will be rapidly developed and come into widespread use in the future.

Further, recently, so-called dual view displays (hereinafter abbreviated to “DV displays”), which allow a viewer to view different images on a single display, have been earnestly developed. A DV display is configured to display two different images simultaneously. A viewer can view the two different images on the DV display from specific different direction.

It is therefore preferable that light emitted from the DV display has luminance directivities in respective directions which enable the viewer to view the two different images.

Pixels themselves which constitute a liquid crystal panel do not emit light. Therefore, a luminance directivity of light emitted from the liquid crystal panel remarkably depends on a luminance directivity of backlight emitted by a backlight.

However, as illustrated in FIG. 13, the backlight has a luminance directivity in a front direction of a display 1000 (viewing angle 0° in FIG. 14) in general.

On the other hand, dual view display (hereinafter, referring to as “DV display) performed on a DV display is mostly such that display is directed to viewing angles of ±45°.

Because of this, the luminance of the backlight light is reduced by about 60% in the vicinity of the viewing angles of ±45°, when a backlight unit having a luminance directivity in the direction of the viewing angle of 0° as illustrated in FIG. 14 is employed in the DV display. Such a huge reduction in luminance results in poor display quality. Moreover, in order to have a high luminance in the vicinity of ±45°, it is necessary to increase the luminance of the backlight as a whole. This results in a wasteful increase in power consumption of the backlight.

To deal with these problems, Patent Literature 1 discloses a backlight unit for DV display (hereinafter, simply referred to as “DV backlight unit).

This will be described below, referring to FIG. 14.

FIG. 14 is a perspective view illustrating a conventional DV backlight unit.

Here, assume that a front side of the DV backlight unit is a side facing a liquid crystal panel (not illustrated) and a back side of the DV backlight unit is a side opposite to the front side. The DV backlight unit includes, in the order of from its front side to back side, a prism sheet 1015, a prism sheet 1014, a defusing sheet 1013, a light guide plate 1012, and a reflecting plate 1016. Further, the DV backlight unit includes a plurality of light sources 1011 provided along one of 4 edges of the light guide plate 1012.

The prism sheet 1014 has a prism forming surface facing the light guide plate 1012, and prism axes (prism ridgeline) parallel to a vertical direction of a liquid crystal screen.

The prism sheet 1015 has a prism forming surface facing the liquid crystal panel, and prism axes parallel to a horizontal direction of the liquid crystal screen.

Light emitted from the light sources 1011 enters one side surface of the light guide plate 1012, and then is emitted from a surface of the light guide plate 1012 as plane light.

The light emitted from the light guide plate 1012 enters the two prism sheets 1014 and 1015 through the diffusing sheet 1013, thereby being converted into light having luminance directivity in two directions. Then, the light enters the liquid crystal panel capable of performing the DV display.

As described above, the DV backlight unit of FIG. 14 makes it possible to attain high luminance in two directions, namely, rightwards and leftwards.

### CITATION LIST

### Patent Literature

[Patent Literature 1]
Japanese Patent Application Publication, Tokukai, No. 2009-86622 (published on Apr. 23, 2009)

### SUMMARY OF INVENTION

### Technical Problem

Furthermore, in order to achieve a simpler designing process and a lower cost in maintenance of production facility, it is recently preferable that a backlight unit has a common configuration regardless of whether the backlight unit is of small size, medium size, or large size.

According to the DV backlight unit illustrated in FIG. 14, the light sources 1011 are provided along one edge of the light guide plate 1012.

Therefore, if the DV backlight is of large size (large surface), the light emitted from a far end part of the light guide plate 1012 which part is far from the light sources 1011 is light having repeatedly reflected inside the light guide plate 1012. In general, white light reduces its luminance in low wavelengths after repeatedly reflected.

Thus, a large-sized DV backlight unit as configured in FIG. 14 is such that the plane light emitted from the light guide plate 1012 is different in color at a near end part and the far end part of the light source 1012, thereby causing a display quality deterioration.

The present invention was accomplished in view of the aforementioned problems, and an object of the present invention is to prevent display quality deterioration due to large-sizing, and to allow emission of light having luminance directivity in different directions.

### Solution to Problem

In order to attain the object, a backlight unit according to the present invention includes: light sources; light guide members, the light sources including a first light source and a second light source, and the light guide members including a first light guide member and a second light guide member, the first light source being provided to a side surface of the first light guide member, the second light source being provided to a side surface of the second light guide member, the first and second light sources being provided across the first and the second light guide members in plane view; and an optical path changing member for changing an optical path of light passing through the optical path changing member, the optical path changing member having a light incidence surface for receiving light emitted directly from the first or second light guide member, and a light exit surface for emitting, directly to a display panel outside of the backlight unit, the light thus received via the light incidence surface.

The backlight unit with the above configuration includes the first and second light sources positioned across the first and the second light guide members, the first light guide member provided to the side surface of the first light source, the second light guide member provided to the side surface of the second light source, and the optical path changing member for changing the optical path of the light passing through the optical path changing member.

This configuration makes it possible to emit, from the light exit surface of the optical path changing member, light having luminance directivity whose luminance distribution is maximum in at least two directions different from a normal direction of the display screen of the display panel.

Furthermore, because the first and second light sources are positioned across the first and second light guides, the backlight unit can be large-sized without the problem of color differences across the display panel in the plane view, thereby preventing display quality deterioration.

### Advantageous Effects of Invention

A backlight unit according to the present invention includes: light sources; light guide members, the light sources including a first light source and a second light source, and the light guide members including a first light guide member and a second light guide member, the first light source being provided to a side surface of the first light guide member, the second light source being provided to a side surface of the second light guide member, the first and second light sources being provided across the first and the second light guide members in plane view; and an optical path changing member for changing an optical path of light passing through the optical path changing member, the optical path changing member having a light incidence surface for receiving light emitted directly from the first or second light guide member, and a light exit surface for emitting, directly to a display panel outside of the backlight unit, the light thus received via the light incidence surface.

With this configuration, it becomes possible to large-size a backlight unit without the fear of display quality deterioration, and to make it possible for such a backlight unit to emit light with luminance directivity in different directions.

### BRIEF DESCRIPTION OF DRAWINGS

FIG. 1 is a view illustrating an overall configuration of a display system according to one embodiment of the present invention.

FIG. 2 is a view illustrating how the display system performs DV display, and luminance of an image displayed by the DV display.

FIG. 3 is a cross sectional view illustrating configurations of a liquid crystal display panel and a BL unit of the display system.

FIG. 4 is a view illustrating an optical path as to the BL unit provided with a diffusing sheet serving as an optical path changing member.

FIG. 5 is a view illustrating an optical path as to the BL unit provided with a lens sheet serving as an optical path changing member.

FIG. 6 is a plane view illustrating a light guide plate having a dot-processed back surface.

FIG. 7 is a plane view illustrating a light guide plate having a prism-processed back surface.

FIG. 8 is a plane view of a liquid crystal panel provided with a parallax barrier.

FIG. 9 is a view illustrating how light is emitted to an A side and a B side of the liquid crystal panel.

FIG. 10 is a block diagram illustrating a configuration of the display system provided with a calculation section.

FIG. 11 is a view illustrating a BL unit according to another embodiment of the present invention.

FIG. 12 is a side view illustrating a light guide plate provided with light sources for its side surfaces facing each other.

FIG. 13 is a view illustrating a general display and its luminance directivity.

FIG. 14 is a perspective view illustrating a configuration of a conventional DV backlight unit.

### DESCRIPTION OF EMBODIMENTS

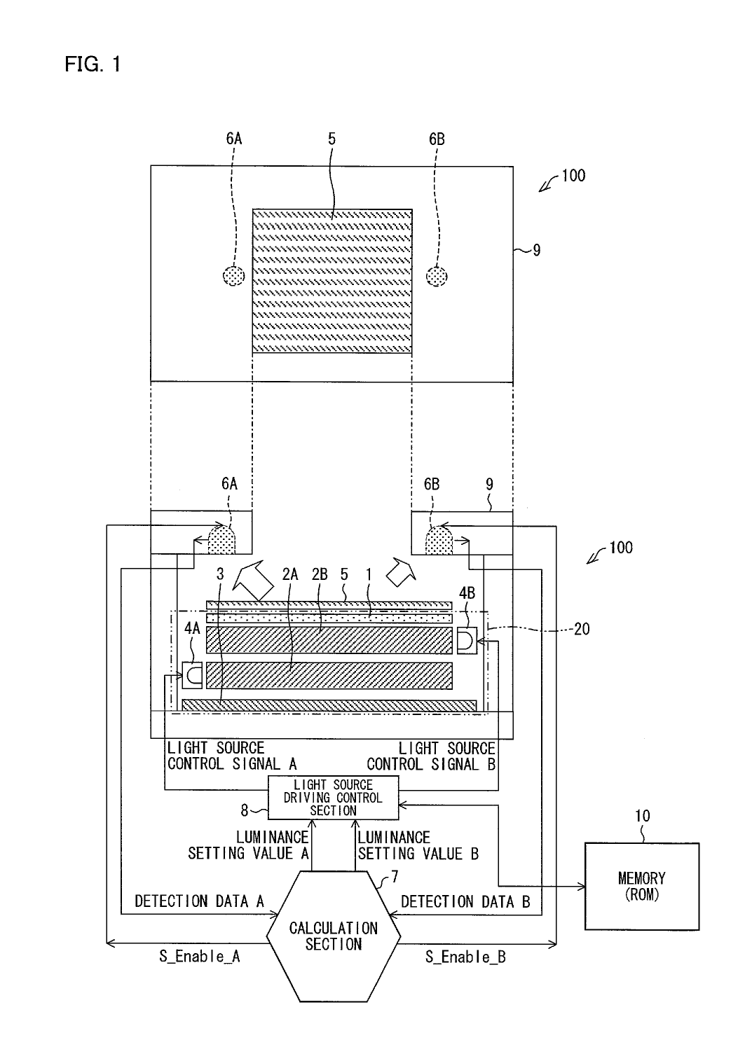

The following description will discuss an embodiment of the present invention with reference to FIGS. 1 through 12. In the following, explanation of some configuration may not be repeated in a certain item if the explanation has been made in other items. It should be regarded that in the certain item the configuration whose explanation is omitted is identical with the corresponding configuration in the other items in which the configuration has been described. For convenience, members having functions identical to those described in items are given identical reference numerals, and descriptions of the respective members are omitted as appropriate.

### [1. Configuration of Display System 100]

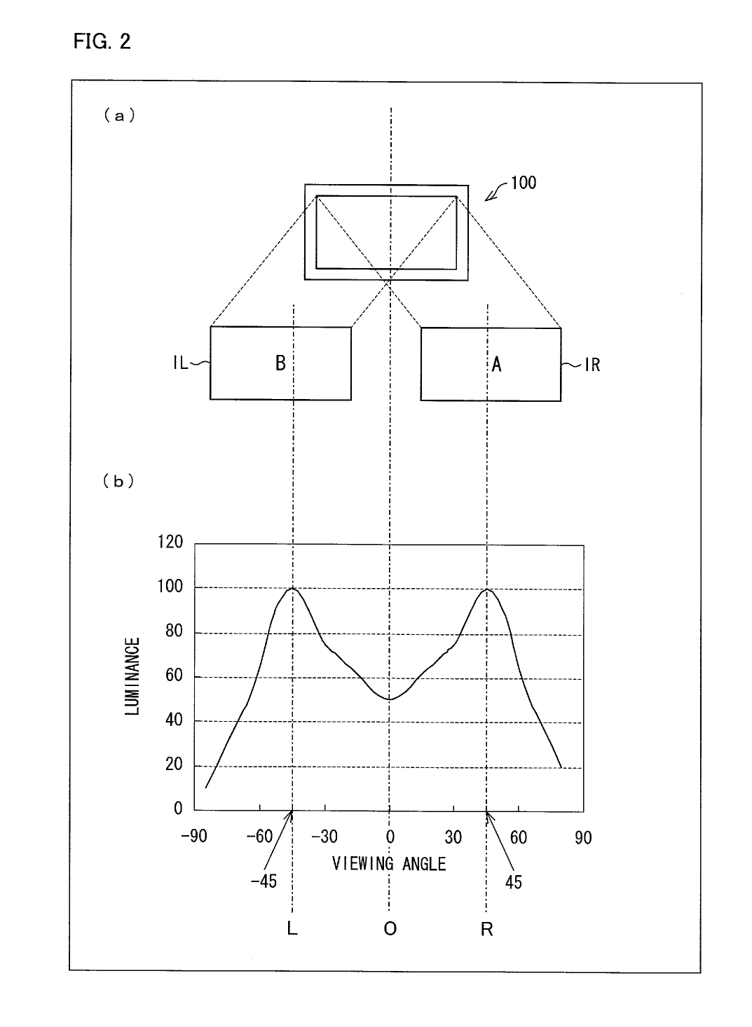

The following description will schematically discuss, with reference to FIGS. 1 and 2, how a display system (display device) 100 in accordance with an embodiment of the present invention is configured.

FIG. 1 is a view illustrating an overall configuration of a display system 100. As illustrated in FIG. 1, the display system 100 includes a liquid crystal panel (display panel) 5 having an image display region, a BL (backlight) unit 20 for backlighting the liquid crystal panel 5, a frame 9 for housing the liquid panel 5 and the BL unit 20 with an opening opened for the image display region, and sensors (luminance sensors) 6A and 6B for detecting light intensity of light emitted from the liquid crystal panel 5.

Further, the display system 100 includes (i) a calculation section 7 for controlling light intensity of the light sources 4A and 4B according to outputs from the sensors 6A and 6B, (ii) a light source driving control section 8, and (iii) a memory 10.

The BL unit 20 includes (i) an optical path changing member 1, which serves as a light exit surface of the BL unit 20, (ii) a light guide plate (first light guide member) 2A and a light guide plate (second light guide member) 2B, (iii) a reflecting plate (reflecting member) 3, and (iv) a light source (first light source) 4A and a light source (second light source) 4B. The BL unit 20 has luminance directivity in two different directions, as described later.

The display system 100 is a display system capable of displaying two or more images viewed in different directions simultaneously.

For example, the display system 100 is capable of performing dual view display (hereinafter, referred to as DV display) for displaying two images simultaneously, or performing quartet view display (hereinafter, referred to as CV display) for displaying four images simultaneously.

In this Description of the present application, the explanation is made mainly based on such assumption that the display system 100 is a display system capable of performing the DV display.

FIG. 2 is a view illustrating how the DV display of the display system is performed, and luminance of an image displayed by the DV display.

As illustrated in (a) of FIG. 2, the display system 100 is capable of simultaneously displaying both of a right-hand side image IR being viewable when the display system 100 is viewed from its right-hand side, and a left-hand side image IL being viewable when the display system 100 is viewed from its left-hand side. In this Description of the present application, the side associated with the right-hand side image IR (right-hand side of FIG. 2) is referred to as “A side”, and the side associated with the left-hand side image IL (left-hand side of FIG. 2) is referred to as “B side”.

As illustrated in (b) of FIG. 2, the light emitted from the display system 100 is such that its luminance in the right front direction (direction of viewing angle of 0°) is kept low, while the luminance is peaked at viewing angles of ±45°, respectively.

In the Description of the present application, an angle to view the display system 100 from its right front is referred to as the viewing angle of 0°, and viewing angles on A side with respect to the viewing angle of 0° are referred to as + viewing angles, and viewing angles on A side with respect to the viewing angle of 0° are referred to as − viewing angles.

With this configuration, the display system can display the right-hand side image IR to a user on the A side and the left-hand side image IL to a user on the B side with a good display quality.

Further, the display system 100 is not limited to the DV display or CV display, and may be capable of performing 3D (3 dimensional) display. For example, the display system 100 can be modified in terms of relationship between the parallax barrier and pixel structure, thereby being a display system capable of performing 3D display for naked eyes without the need of 3D glasses.

By way of example, the following mainly describes the display system 100 as a display system capable of performing the DV display. Constituent elements of the display system 100 will be described below one by one.

(Overall Configuration of BL Unit 20)

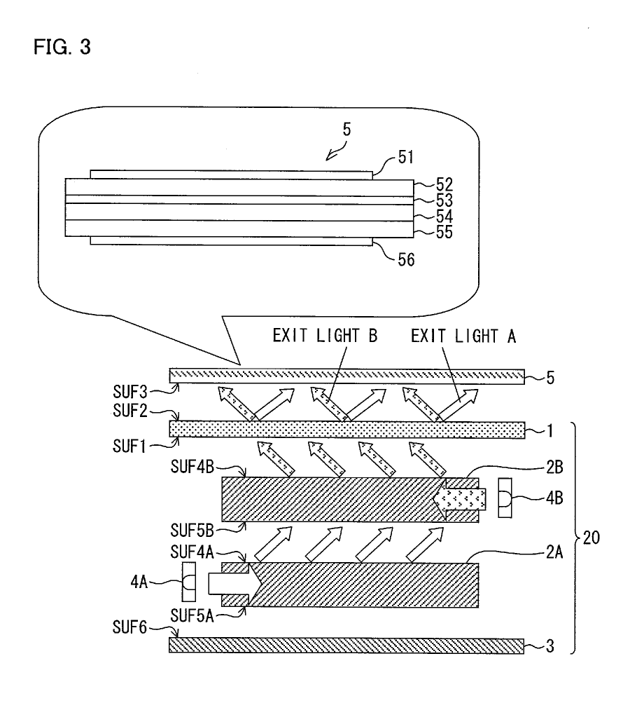

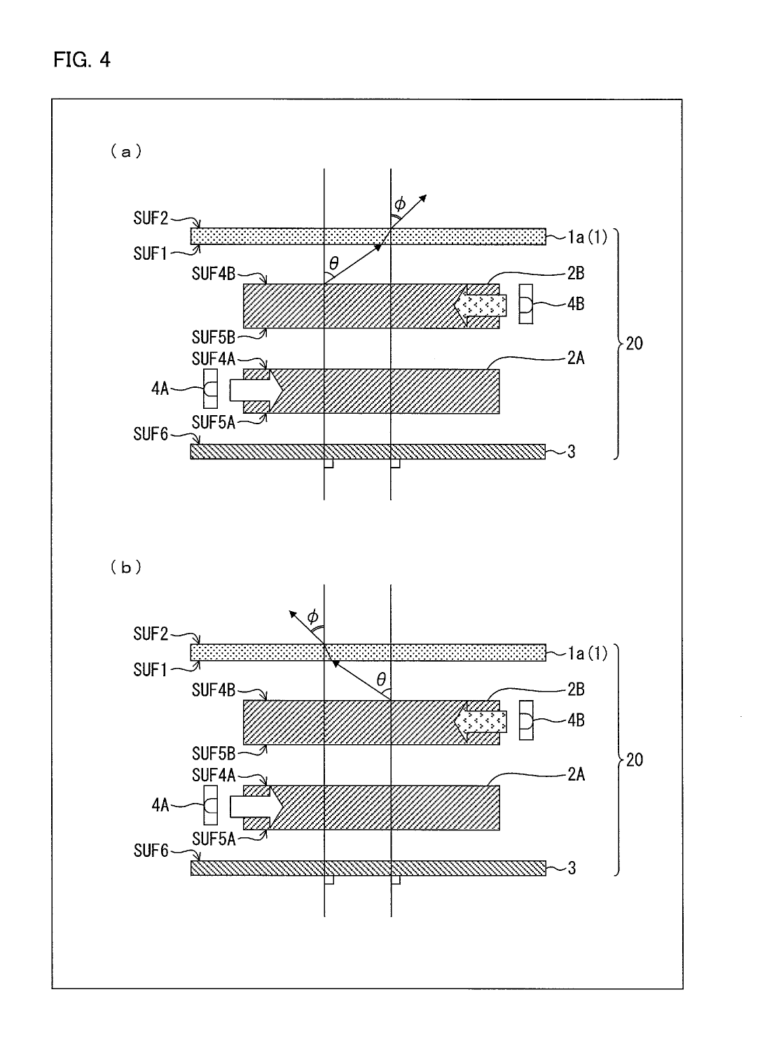

The BL unit 20 is described below, referring to FIGS. 3 and 4.

FIG. 3 is a cross-sectional view illustrating configurations of the liquid crystal panel 5 and the BL unit 20.

As illustrated in FIG. 3, the BL (backlight) unit 20 includes the optical path changing member 1, the light guide plate (first light guide member) 2A, the light guide plate (second light guide member) 2B, the reflecting plate (reflecting member) 3, the light source (first light source) 4A, and the light source (second light source) 4B.

In the Description of the present application, what is meant by the wording “front” is the side on which the display panel 5 displays an image (that is, the side on which the user views the liquid crystal panel 5) and what is meant by the wording “back” is the opposite side of the side on which the liquid crystal panel 5 displays the image.

The BL unit 20 includes, in the order from the front side to the back side, the liquid crystal panel 5, the optical path changing member 1, the light guide plate 2B, the light guide panel 2A, and the reflecting plate 3.

Further, the BL unit 20 includes the light source 4A facing one side surface of the light guide plate 2A, and the light source 4B facing one side surface of the light guide plate 2B.

The light source 4A is provided to one edge (one side surface) of the light guide plate 2A, while the light source 4B is provided to one edge (one side surface) of the light guide plate 2B, in such a way that the light sources 4A and 4B are positioned across the light guide plates 2A and 2B in plane view of the BL unit 20.

The light guide plates 2A and 2B may be such that the light guide plate 2A is provided on the front side and the light guide plate 2B is provided on the back side.

As described above, the BL unit 20 is provided with the light sources 4A and 4B positioned across the light guide plate in plane view, the light guide plate 2A provided with the light source 4A facing one side surface of the light guide plate 2A, the light guide plate 2B provided with the light source 4B facing one side surface of the light guide plate 2B, and the optical path changing member 1 for changing the optical path of the light passing through the optical path changing member 1.

With this configuration, it is possible to emit, from a light exit surface SUF2 of the optical path changing member 1, light (exit light A and B) having luminance directivity peaked in at least two directions different from a normal direction of the display screen of the liquid crystal panel 5.

Here, a backlight of side light type as above is configured such that light from a light source enters a light guide from a side surface of the light guide and the light is reflected inside the light guide and emitted in the form of plane light from a light exit surface of the light guide.

However, the reflection reduces light intensity of the light on a low wavelength side, thereby causing a color change along the reflection.

Thus, if it is configured as in Patent Literature 1 that only one light guide for emitting plane light for emitting plane light from light received on one side surface of the light guide is provided, the in-plane color change of the light occurs when BL unit 20 is large (having a large surface).

One option is to configure a backlight unit to have a luminance directivity in two directions by providing a light source to each side of one light guide plate.

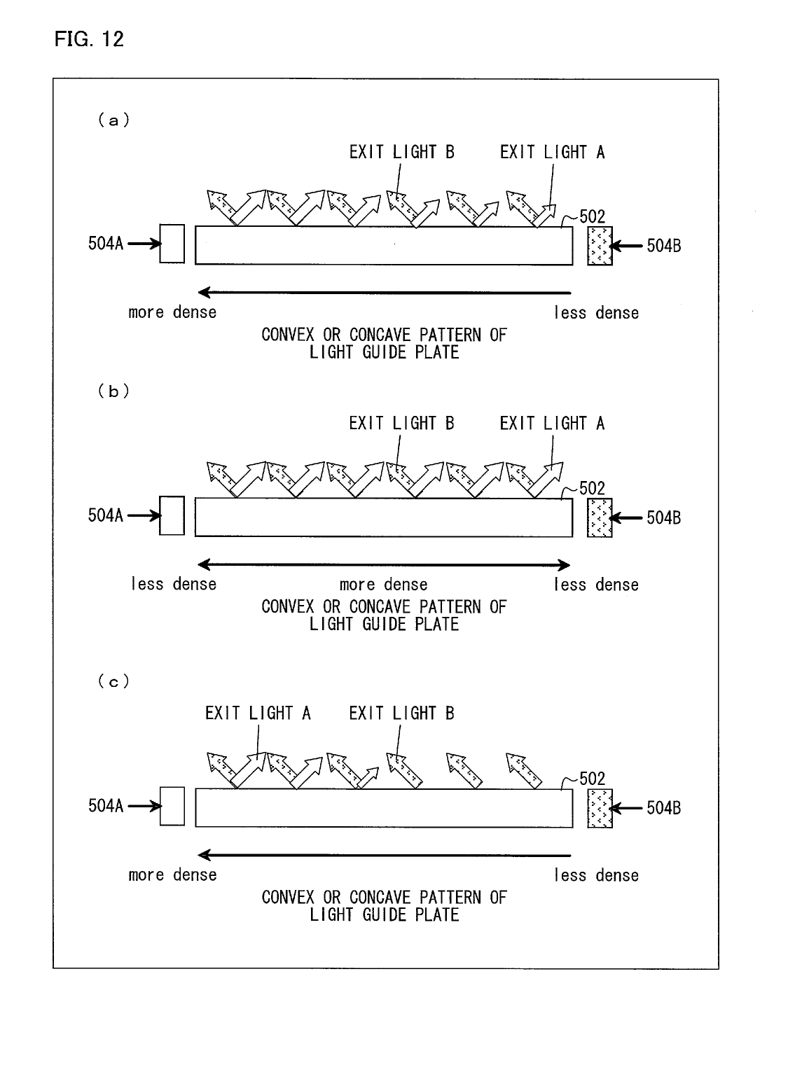

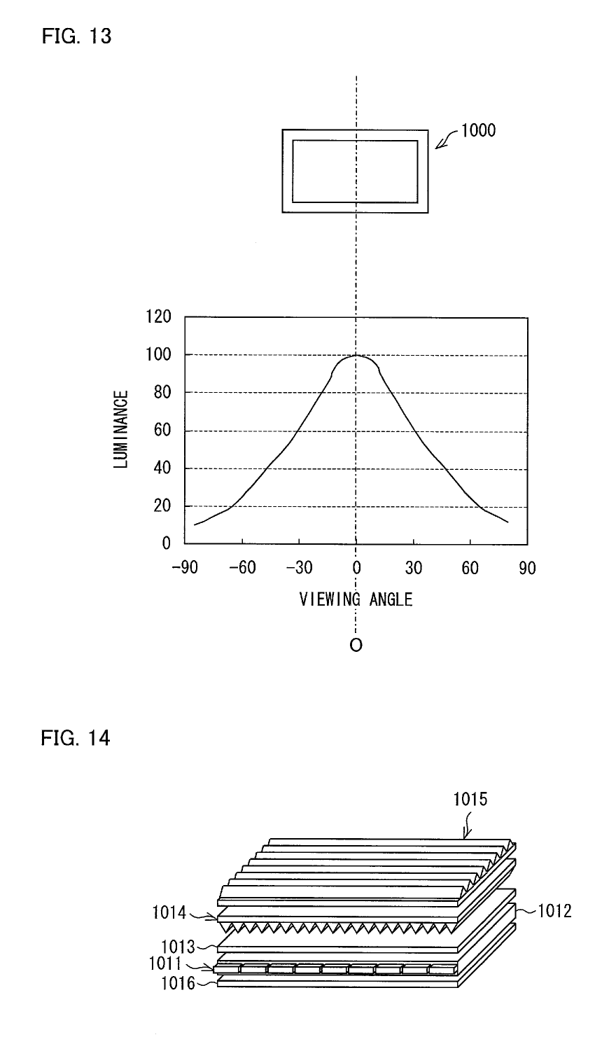

FIG. 12 is a side view illustrating a light guide plate provided with light sources 504A and 504B respectively to side surfaces facing each other. (a) of FIG. 12 illustrates how exit light is emitted from a light guide plate having a convexoconcave pattern whose density is more dense from the right-hand side to the left-hand side in FIG. 12. (b) of FIG. 12 illustrates how exit light is emitted from a light guide plate having a convexoconcave pattern whose density is less dense from the center part to the edge parts. (c) of FIG. 12 illustrates how exit light is emitted from a large-side light guide plate having a convexoconcave pattern whose density is more dense from the right-hand side to the left-hand side in FIG. 12.

The light guide plates 502 illustrated in (a) to (c) of FIG. 12 is such that the light source 504A is provided to one of the side surfaces, which face each other, of the light guide plates 502, and the light source 504B is provided to the other one of the side surfaces.

The light guide plate 502 illustrated in (a) of FIG. 12 has a back surface having the convexoconcave pattern whose density is more dense from (i) the side surface to which the light source 504B is provided to (ii) the side surface to which the light source 504A is provided. That is, the light guide plate 502 in (a) of FIG. 12 has a convexoconcave pattern for providing a uniform in-plane luminance of the exit light B emitted from the light source B.

Firstly, consider a light guide plate for a BL unit for use in a small-sized display device such as portable phones, smart phones, etc.

In case of a small-sized light guide plate 502, the exit light from the light sources 504A and 504B has a short optical path inside the light guide plate 502.

Thus, in case of the small-sized light guide plate 502, it is possible to emit the exit light A from the light exit surface of the light guide plate 502 sufficiently even if the convexoconcave pattern of the light guide plate 502 is configured based on the side on which the light source 504B is provided (that is, the convexoconcave pattern of the light guide plate 502 is configured such that the density of the convexoconcave pattern is less dense toward the light source 504B and more dense toward the light source 504A), because the light emitted from the light source 504A can reach the opposite side surface sufficiently even if the light is weakened as the opposite side where the light source 504B is provided. However, in this case, there is still the problem of the uneven in-plane luminance of the exit light A.

To solve this problem, the convexoconcave pattern of the light guide plate 502 is configured such that the density of the convexoconcave pattern is more dense in the central part of the light guide plate 502 and becomes less dense toward both the side surfaces, as illustrated in (b) of FIG. 12. With this configuration, in-plane unevenness of the exit light A emitted from the light exit surface of the light guide plate 502 after received from the light source 504A can be identical with in-plane unevenness of the exit light B emitted from the light exit surface of the light guide plate 502 after received from the light source 504B.

As described above, in case of the small-sized light guide plate, the short optical path in the light guide plate 502 allows regulating the in-plane unevenness of the exit light A and the in-plane unevenness of the exit light B by appropriately configuring the convex and concave pattern of the light guide plate, even if only one light guide plate is provided.

As described above, the white light changes its color as repeatedly reflected inside a light guide plate because the light intensity of the white light in the low-wavelength side is attenuated as repeatedly reflected as such. Therefore, it is preferable that the number of times the light is reflected inside the light guide plate is smaller.

That is, it is preferable that the light entered the light guide plate 502 from the light sources 504A and 504B is emitted as the exit light A and B from the light exit surface without being reflected from the opposite side surfaces.

The short optical length in the small-sized light guide plate 502 is not sufficient to make the in-plane luminance unevenness of the exit light A and B uniform and to exit the whole light from the light sources 504A and 504B from the light exit surface of the light guide plate 502 before the light reaches the opposite side surfaces (thus, part of the light from the light sources 504A and 504B is reflected on the opposite side surfaces).

However, for example, in case of such a small-sized light guide plate as a backlight for a less than 15-inch panel, the number of time the light travelling from the light sources 504A and 504B to the opposite side surfaces of the light guide plate 502 is reflected inside the light guide plate 502 is small because the optical path inside the light guide plate 502 is short. Thus, the color change in the light from the light sources 504A and 504B due to the reflection on the opposite side surfaces is not so problematic.

As described above, in case of small-sized light guide plates, the in-plane luminance unevenness can be alleviated and the exit light A and B can be emitted without a problematic color change by appropriately configuring the convexoconcave pattern, even if the single light guide plate 502 is provided.

On the other hand, in case of a backlight for such a large-sized panel as 20-inch or grater panel, the light guide plate 502 has a long optical path.

Assume that, as illustrated in (c) of FIG. 12, the large-sized light guide plate 502 has a back surface having a convexoconcave pattern having a density more dense from the side surface to which the light source 504B is provided, toward the side surface to which the light source 504A is provided.

That is, assume that the light guide plate 502 has such a convexoconcave pattern, as illustrated in (c) of FIG. 12, that causes the in-plane luminance of the exit light B emitted from the light guide 504B to be uniform.

On the contrary to the short optical path of the small-sized light guide plate 502 where the exit light A reaches the side surface to which the light source 504B is provided, the long optical path of the large-sized light guide plate 502 does not allow the exit light A to reach the side surface to which the light source 504B is provided, thereby causing in-plane luminance unevenness of the exit light A.

In this case, assume that the large-sized light guide plate 502 has such a convexoconcave pattern as illustrated in (b) of FIG. 12 that the density of the convexoconcave pattern in more dense in the central part of the light guide plate 502 and less dense toward the edge parts of the light guide plate 502, That is, assume that the convexoconcave pattern of the light guide plate 502 is configured such that the light entering the light guide plate 502 from the light source 504A and 504B is reflected on the opposite side surfaces to the side surfaces to which the light sources 504A and 504B are provided respectively.

In this case, however, the number of times the light is reflected is large due to the long optical path, and the light is reflected on the opposite side surfaces to the side surfaces to which the light sources 504A and 504B are provided respectively. Therefore, the in-plane color unevennesses in the exit light A and B are large.

As such, by providing only one light guide plate 502, it is not possible to attain a large-sized BL unit in which the luminance unevenness and color unevenness in both the exit light A and the exit light B are prevented.

To overcome this problem, the BL unit 20 is provided with the light sources 4A and 4B positioned across the light guide plates 2A and 2B in plane view. That is, the light sources A and 4B are provided to both the side surfaces facing each other in plane view. This makes it possible to prevent the color differences across the display panel in plane view even if BL unit 20 is large (having a large surface), thereby preventing display quality deterioration.

Moreover, the BL unit 20 is provided with the two light guide plates 2A and 2B, thereby making it possible to appropriately configure the convexoconcave patterns of the light guide plates 2A and 2B individually. With this configuration, the BL unit 20 is configured such that the in-plane luminance unevenness and the in-plane color unevenness of the exit light A and the exit light B can be prevented.

That is, the BL unit 2o is provided with a plurality of light guide plates 2A and 2B, thereby making it possible to appropriately configure the convexoconcave pattern on the back surfaces of the light guide plates 2A and 2B, individually. With this configuration, the BL unit 20 is such that the in-plane luminance unevenness and the in-plane color unevenness of the exit light A and the exit light B can be prevented.

(Optical Path Changing Member 1)

The optical path changing member 1 is a kind of so-called optical sheet having a function of reflecting, diffusing, or focusing the exit light emitted from the light guide plate 2, In the present embodiment, the optical path changing member 1 is a member for changing the optical path of light passing the optical path changing member 1 by at least optical property of the optical path changing member 1.

As illustrated in FIG. 3, the optical path changing member 1 has (i) a light incidence surface (incidence surface) SUF1 for directly receiving the light emitted from the light guide plate 2B facing the back surface of the optical path changing member 1, and (ii) a light exit surface (exit surface) for emitting the light directly to the liquid crystal panel 5 provided outside the BL unit 20.

The light incidence surface SUF1 and the light exit surface SUF2 are opposite to each other in a vertical direction of the drawing.

The light incidence surface SUF1 may be flat or have a non-flat surface having convexoconcave shapes. That is, because the BL unit 20 has luminance directivity in two directions by having the plurality of the light sources 4A and 4B and the plurality of light guide plates 2A and 2B, it is not necessary to have, as in FIG. 14, a prism sheet 1014 having convex shapes protruded toward the light guide plate 1013, thereby making it possible for the light incidence surface SUF1 to be flat.

Moreover, the light incidence surface SUF1 may be non-flat.

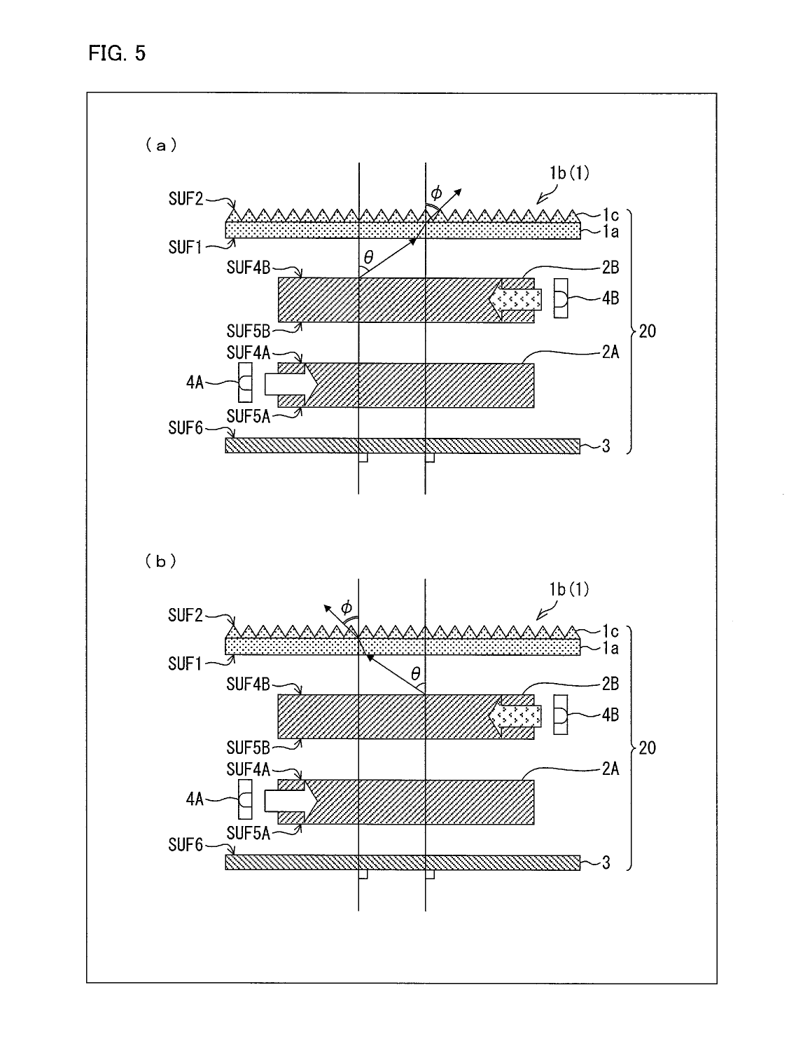

As illustrated in FIGS. 4 and 5, the optical path changing member (optical sheet) 1 can be, for example, a diffusing sheet 1a as illustrated in FIG. 4 or a lens sheet 1b as illustrated in FIG. 5.

FIG. 4 is a view illustrating an optical path of the BL unit 20 in which the optical path changing member 1 is the diffusing sheet 1a. FIG. 5 is a view illustrating an optical path of the BL unit 20 in which the optical path changing member 1 is the lens sheet 1b.

The optical path changing member 1 has an optical property (Φ<θ) where Φ is a light exit angle of the light emitted from the light exit surface SUF2 of the optical path changing member 1 and θ is a light exit angle of the light emitted from the light exit surface SUF4B of the light guide plate 2B.

Therefore, as illustrated in FIGS. 4 and 5, the light emitted from the light source 4A can be emitted as backlight light having luminance directivity inclined rightward (inclined to the A side, for example, by a viewing angle of)+45° with respect to the normal direction of the light exit surface SUF2. On the other hand, the light emitted from the light source 4B can be emitted as backlight light having luminance directivity inclined leftward (inclined to the B side, for example, by a viewing angle of −45°) with respect to the normal direction of the light exit surface SUF2.

Moreover, as illustrated in FIG. 3, the light emitted from the light exit surface SUF2 of the optical path changing member 1 is directly irradiated on the liquid crystal panel 5 provided outside the BL unit 20.

In the other words, the BL unit 20 is such that the sheet member between the liquid crystal panel 5 and the light guide plate 2B is only one optical path changing member 1. Therefore, a smaller number of the optical path changing path members (that is, a smaller number of members interposing the light guide plate 2B and the liquid crystal panel 5) is provided herein than in the DV backlight unit described in Patent Literature 1, thereby attaining a higher use efficiency of the light emitted from the light guide plate 2B.

(Diffusing Sheet 1a)

Next, referring to FIG. 4, described is a case where the optical path changing member 1 is a diffusing sheet 1a.

(a) of FIG. 4 illustrates how the exit light from the light source 4A is emitted from the light exit surface SUF4B of the light guide plate 2B and the light exit surface SUF2 of the diffusing sheet 1a. (b) of FIG. 4 illustrates how the exit light from the light source 4B is emitted from the light exit surface SUF4B of the light guide plate 2B and the light exit surface SUF2 of the diffusing sheet 1a.

The light diffusing sheet 1a, illustrated in (a) of FIG. 4, has a surface (an incidence surface SUF1 or a light exit surface SUF2) having minute shapes or contains a light scattering material. Generally, the optical property (Φ<θ) of the light diffusing sheet 1a does not depend on direction. It is, however, possible to configure the light diffusing sheet 1a to have the optical property in a specific direction.

In a case where the light diffusing sheet 1a is configured to have the optical property in the specific direction, it is preferable to configure the light diffusing sheet 1a to have the optical property in the directions in which the light sources 4A and 4B emit light.

The diffusing sheet 1a is slightly less effective than the lens sheet 1b when the optical property is not directionally dependent. On the contrary, it can be said that the diffusing sheet 1a has the optical property (Φ<θ) isotropically. Thus, the diffusing sheet 1a is suitable as the optical path changing member 1 for CV display (FIG. 7).

As illustrated in (a) of FIG. 4, the light emitted from the light source 4A enters the light guide plate 2A from a side surface of the light guide plate 2A. Then, the light is emitted from the light exit surface SUF4A of the light guide plate 2A, passes through the light guide plate 2B and is emitted at the light exit angle θ from the light exit surface SUF4B of the light guide plate 2B. The light thus emitted enters the diffusing sheet 1a.

Then, the diffusing sheet 1a receives, on the light incidence surface SUF1 thereof, the light emitted at the light exit angle θ from the light exit surface SUF4B of the light guide plate 2B. The diffusing sheet 1a emits the light from the light exit surface SUF2 thereof at the light exit angle Φ (Φ<θ), which is changed by the diffusing sheet 1a, thereby emitting the light to the liquid crystal panel 5 directly.

On the other hand, as illustrated in (b) of FIG. 4, the light emitted from the light source 4B enters the light guide plate 2B from a side surface of the light guide plate 2B. Then, the light is emitted at the light exit angle θ from the light exit surface SUF4B of the light guide plate 2B. The light thus emitted enters the diffusing sheet 1a.

Then, the diffusing sheet 1a receives, on the light incidence surface SUF1 thereof, the light emitted at the light exit angle θ from the light exit surface SUF4B of the light guide plate 2B. The diffusing sheet 1a emits the light from the light exit surface SUF2 thereof at the light exit angle Φ (Φ<θ), which is changed by the diffusing sheet 1a, thereby emitting the light to the liquid crystal panel 5 directly.

The diffusing sheet 1a of the present embodiment includes a transparent resin serving as a medium (base material) and a light scattering agent (scattering fine particles) dispersed in the transparent resin.

Examples of the transparent resin include thermoplastic resins and thermosetting resins such as a polycarbonate resin, an acrylic resin, a fluoric acrylic resin, a silicone acrylic resin, an epoxy acrylate resin, a polystyrene resin, a cycloolefin polymer, a methyl styrene resin, a fluorine resin, polyethylene terephthalate (PET), polypropylene, an acrylonitrile styrene copolymer, and an acrylonitrile polystyrene copolymer.

Examples of the light scattering agent (light scattering fine particles) include (i) transparent fine particles of an inorganic material and (ii) transparent fine particles of a resin. Examples of the transparent fine particles of the inorganic material include (i) fine particles of oxides such as silica (SiO₂), alumina (Al₂O₃), magnesium oxide (MgO), titanic, (ii) fine particles of calcium carbonate, and (iii) fine particles of barium sulfate.

Examples of the transparent fine particles of the resin include (i) particles of an acrylic resin, a styrene resin, an acrylic styrene resin, or these resins which have been crosslinked, (ii) particles of a melamine-formaldehyde resin, (iii) particles of polytetrafluoro-ethylene, a perfluoroalkoxy resin, or a fluororesin of a copolymer such as a copolymer of tetrafluoroethylene and hexafluoropropylene or a copolymer of polyfluorovinylidene and ethylene tetrafluoroethylene, and (vi) particles of a silicone resin.

Note here that the wavelength of visual light substantially falls within a range from 350 nm to 800 nm, and therefore, light scattering fine particles whose average particle diameter has an order equal to that of the wavelength of visual light (that is, an order of 100 nm) can scatter light.

In other words, the light scattering fine particles should have a particle diameter of not less than 100 nm so as to scatter light. Further, it is preferable that each of the light scattering fine particles has a particle diameter whose order is larger than that of the wavelength of visual light, i.e., not less than 1 μm, so as to suitably scatter light. That is, the light scattering fine particles preferably have an average particle diameter of not less than 1 μm, more preferably have an average particle diameter of approximately 2 μm.

The transparent resin of the light diffusing sheet 1a contains approximately 5% by mass of the light scattering fine particles. Needless to say, how much the transparent resin contains the light scattering fine particles slightly varies depending on how much light should be scattered (which is defined by, for example, Haze). In a case where the transparent resin contains the light scattering fine particles in a mass much more than 5% by mass, Haze is unnecessarily increased. This causes an increase in distance for which light travels in the light diffusing sheet 1a, whereby a transmittance is remarkably reduced.

It is preferable that, in a case where the light diffusing sheet 1a employs the light scattering fine particles as a light scattering agent, the light diffusing sheet 1a has a thickness which falls within a range from 0.1 mm to 5 mm. This is because the light diffusing sheet 1a having the thickness can have a preferable optical property, i.e., optimal light diffusion and luminance. On the contrary, a light diffusing sheet 1a having a thickness of less than 0.1 mm cannot desirably scatter light. Further, a light diffusing sheet 1a having a thickness of more than 5 mm contains a large amount of resin. This causes the light diffusing sheet 1a to absorb light, whereby a luminance is reduced.

Note that the light diffusing sheet 1a of the present embodiment has a Haze of 75% and a total light transmittance of 86%. The light diffusing sheet 1a of the present embodiment preferably has a Haze of not less than 70% and a total light transmittance of not less than 50%.

This allows the light diffusing sheet 1a to have a light exit angle Φ of +45° in a case where the light guide plate 2 has a light exit angle θ of +70°±5° (light exit angle of not less than 65° but not more than 75°).

In a case where a thermoplastic resin is employed as the transparent resin, the thermoplastic resin can contain gas bubbles as a light scattering agent. Inner surfaces of the gas bubbles formed in the thermoplastic resin diffusely reflect light. How much the thermoplastic resin which contains gas bubbles scatters light is equal to or more than how much the transparent resin, in which light scattering fine particles are dispersed, scatters light. Therefore, in a case where the thermoplastic resin contains gas bubbles, it is possible to further reduce the thickness of the light diffusing sheet 1a.

Examples of the light diffusing sheet 1a made from the thermoplastic resin which contains gas bubbles include white PET and white PP. White PET is prepared as follows: a filler which is insoluble in PET, such as a resin, titanium oxide (TiO₂), barium sulfate (BaSO₄) or calcium carbonate, is dispersed in PET, and then the PET is extended by use of a biaxial orientation method so that gas bubbles are generated around the filler.

Note that the light diffusing sheet 1a made from the thermoplastic resin needs to be at least uniaxially extended. This is because gas bubbles can be generated around the filler by at least uniaxially extending the light diffusing sheet 1a.

Examples of the thermoplastic resin include (i) polyester resins such as an acrylonitrile polystyrene copolymer, polyethylene terephthalate (PET), polyethylene-2,6-naphlate, polypropylene terephthalate, polybutylene terephthalate, a cyclohexane dimethanol copolymer polyester resin, an isophthalic copolymer polyester resin, a sporoglycol copolymer polyester resin, and a fluorine copolymer polyester resin, (ii) polyolefin resins such as polyethylene, polypropylene, polymethylpentene, and an alicyclic olefin copolymer resin, (iii) an acrylic resin such as polymethyl methacrylate, and (iv) polycarbonate, polystyrene, polyamide, polyether, polyester amide, polyether ester, polyvinyl chloride, a cycloolefin polymer, copolymers thereof, and mixtures thereof. However, the thermoplastic resin is not limited to the above examples.

It is preferable that, the light diffusing sheet 1a which contains gas bubbles as a light scattering agent has a thickness which falls within a range from 25 μm to 500 μm.

It is not preferable that the light diffusing sheet 1a has a thickness of less than 25 μm. This is because such a light diffusing sheet 1a is so soft that it easily wrinkles during production or in the frame 9. It is neither preferable that the light diffusing sheet 1a has a thickness of more than 500 μm. This is because, due to an increase in stiffness, it becomes difficult, for example, to form the light diffusing sheet 1a in a shape of a roll, and to slit the light diffusing sheet 1a, though the light diffusing sheet 1a particularly has no problem with its optical property. That is, the light diffusing sheet 1a becomes less advantageous in thickness than a conventional light diffusing sheet.

### (Minute Convexoconcave Structure)

The light diffusing sheet 1a can have an incidence surface SUF1 or a light exit surface SUF2 having a minutely convexoconcave structure. The minutely convexoconcave structure can be formed, for example, as follows: a pressure is applied to a metal mold having the minutely convexoconcave structure by means of co-extrusion molding or injection molding so that (i) the metal mold comes into contact with a light diffusing sheet 1a to be formed and (ii) the minutely convexoconcave structure is transferred to the light diffusing sheet 1a.

Alternatively, the minutely convexoconcave structure can be formed on an incidence surface SUF1 or a light exit surface SUF2 of a light diffusing sheet 1a with use of a radiation curing resin such a UV (ultraviolet) curing resin. More specifically, the minutely convexoconcave structure can be formed by forming, by means of UV, a convexoconcave shape on the incidence surface SUF1 or the light exit surface SUF2 of the light diffusing sheet 1a which has been formed in a shape of a plate by means of co-extrusion.

A surface state of the incidence surface SUF1 or the light exit surface SUF2 is often numerically indicated by roughness of a convexoconcave shape. Note here that the surface state is indicated by Haze and convexoconcave intervals Sm (hereinafter referred to as “Sm”). Haze is defined by JIS K 7136. Specifically, the surface state is indicated by an average of five measurements obtained by measuring the roughness of the incidence surface SUF1 or the light exit surface SUF2 five times by use of a Haze measuring device. Sm is defined by surface roughness standards JIS B0601-2001, and is an average of measurements obtained by measuring the roughness of the incidence surface SUF1 or the light exit surface SUF2 by use of a contact-type surface roughness measuring device under a condition where a cut-off value is 2.0 mm.

A numerical increase in Haze causes an increase in scattering of light on the incidence surface SUF1 or the light exit surface SUF2. On the contrary, a numerical decrease in Haze causes a decrease in scattering of light on the incidence surface SUF1 or the light exit surface SUF2. A numerical decrease in Sm causes the incidence surface SUF1 or the light exit surface SUF2 to become a more minutely convexoconcave surface. Light is less scattered on a surface having a Haze of less than 20%.

A surface having an Sm of less than 300 μm has small convexoconcave intervals, but is not rough enough for light to be scattered. Therefore, light is less scattered on the surface. On the other hand, a surface having an Sm of more than 900 μm has large convexoconcave intervals, and is rough. Therefore, light is more scattered on the surface, but a front luminance is reduced.

An incidence surface SUF1 or a light exit surface SUF2 having a regular roughness is more advantageous than a surface having an irregular roughness in that the incidence surface SUF1 or the light exit surface SUF2 can bring about a stable scattering effect and can be easily produced.

Haze can be adjusted by various methods. In a case where a convexoconcave shape is physically formed, the haze is adjusted by adjusting a state of a surface of a metal mold and then transferring the convexoconcave shape by means of injection molding or extrusion molding in in-line. The haze may be adjusted by thermally pressing a formed light diffusing sheet or blasting an abrasive to the formed light diffusing sheet in off-line. In a case where a light scattering agent is bled-out under an extrusion condition, the haze is adjusted by adjusting a concentration and/or a particle diameter of light scattering fine particles, and a thickness of a light scattering layer.

According to an extrusion method, an extrusion device extrudes a thermally-melted thermoplastic resin from a T-die to form a plate-like light diffusing sheet. A multilayer plate is formed by use of a co-extrusion method is employed. According to the co-extrusion method, a plurality of extrusion devices extrude a thermally-melted thermoplastic resin from respective multilayer dies such as feed block dies or manifold dies to form the multilayer plate.

(Lens Sheet 1b)

Next, referring to FIG. 5, a case where the optical path changing member 1 is constituted with a lens sheet 1b will be explained below.

(a) of FIG. 5 illustrates how the light emitted from the light source 4A is emitted from the light exit surface SUF4B of the light guide 2B and the light exit surface SUF2 of the lens sheet 1b. (b) of FIG. 5 illustrates how the light emitted from the light source 4B is emitted from the light exit surface SUF4B of the light guide 2B and the light exit surface SUF2 of the lens sheet 1b.

As illustrated in FIG. 5, the lens sheet 1b is configured such that a plurality of prisms 1c arranged in rows are provided on the light exit surface SUF2.

Then, the lens sheet 1b has such an optical property that Φ<θ where Φ is a light exit angle of the light emitted from the light exit surface SUF2 and θ is a light exit angle of the light emitted from the light exit surface SUF4B of the light guide plate 2B.

More specifically, the lens sheet 1b of the present embodiment is configured such that ridgelines (prism axes) of the rows of the prisms 1c are vertical to the light exit directions of the light sources 4A and 4B, whereby Φ<θ is satisfied where Φ is a light exit angle of the light emitted from the light exit surface SUF2 after entering the lens sheet 1b at a predetermined incident angle along a light traveling direction from the light sources 4A and 4B, and θ is a light exit angle of the light emitted from the light exit surface SUF4B of the light guide plate 2B.

With this configuration, a BL unit 20 having luminance directivities in different directions is configured.

The light exit angle Φ from the lens sheet 1b can be controlled by appropriately setting (i) vertex angles of the prisms 1c and (ii) refractive indexes of the lens sheet 1b.

For example, assume that the lens sheet 1b of the present embodiment is configured such that the prisms 1c has (i) an isosceles triangular cross sectional shape, (ii) the vertex angles (prism axes) in a range of 80° to 100°, and (iii) refractive indexes of approximately 1.5.

When the light guide 2B has a light exit angle θ=65°±5°, the lens sheet 1b having a light exit angle Φ of 45° can be realized. The light exit angle Φ is more approximated to 0° when the refractive index of the lens sheet 1b is larger.

(Light Guide Plates 2A and 2B)

The light guide plate 2A receives the light emitted from the light source 4A provided to face one edge surface of the light guide plate 2A, and emits the light from the light exit surface SUF4A to the light guide 2B, via which the light is guided to the incidence surface SUF1 of the optical path changing member 1.

The light guide plate 2B receives light emitted from the light source 4B provided to face one edge surface of the light guide plate 2B, and emits the light from the light exit surface SUF4B directly to the incidence surface SUF1 of the optical path changing member 1.

More specifically, the light guide plates 2A and 2B are transparent resin plates for converting the linear light emitted from the light sources 4A and 4B, so as to provide a surface light source illuminating the liquid crystal panel 5. The light guide plates 2A and 2B have a plate-like shape (rectangular shape). The light exit surfaces 4A and 4B (bottom surfaces 5A and 5B) have a square shape. The light guide plates 2A and 2B has a thickness in a range of 0.2 mm to 3 mm. It should be noted that the thickness of the light guide plates 2A and 2B is not limited to the range.

The light entering the light guide plate 2A from the light source 4A is emitted from the light exit surface SUF4A of the light guide plate 2A. Then, the light passes through the light guide plate 2B, so as to be emitted from the light exit surface SUF4B of the light guide plate 2B, for example, at an angle corresponding to a viewing angle θ=+70°±5°. On the other hand, the light entering the light guide plate 2B from the light source 4B is emitted from the light exit surface SUF4B of the light guide plate 2B, for example, at an angle corresponding to a viewing angle θ=−70°±5°. (see FIGS. 4 and 5)

For example, in case of a large-sized (large-surfaced) backlight unit of 20 inch or greater, the backlight unit may be configured as the BL unit 20 having the light guide plates 2A and 2B, as described in the present embodiment. This makes it possible to attain especially and remarkably the effect of reducing unevenness between luminance of the exit light A and that of the exit light B while also alleviating luminance deterioration on low-wavelength side due to the long optical path.

The BL unit 20 is also applicable to panel sizes smaller than 20 inches. When the BL unit 20 is applied to a backlight whose panel size is 15 inches or greater, it is possible to attain the effect of reducing unevenness between luminance of the exit light A and that of the exit light B while also alleviating luminance deterioration on low-wavelength side due to the long optical path.

The light guide plates 2A and 2B have a plate-like shape in the present embodiment. However, the light guide plates 2A and 2B may have various shapes such as wedge-like shapes, ship-like shapes, and the like. Moreover, the light guide plates 2A and 2B may be made of a synthetic resin having a high transmittance, such as a methacrylic resin, an acrylic resin, a polycarbonate resin, a polyester resin, a vinyl chloride resin, or the like. The light guide plates 2A and 2B are configured such that the light exit surfaces SUF4A and 4B are mirror-surfaced, and the bottom surfaces SUF5A and 5B are rough-surfaced.

The bottom surfaces 5A and 5B of the light guide plates 2A and 2B are prism-processed (to have a plurality of convexoconcave shapes) or dot-processed (to have a plurality of convexoconcave shapes), in order to have uniform luminance or improved luminance.

The light guide plates 2A and 2B are configured such that, even though the two light guide plates 2A and 2B are overlapping each other, the light emitted from the light source 4A is emitted from the light exit surface SUF4B of the light guide plate 2B at an angle θ and the light emitted from the light source 4B is emitted from the light exit surface SUF4B of the light guide plate 2B at an angle θ, by configuring the light guide plates 2A and 2B to have appropriate refractive indexes, appropriate prism pattern arrangement, or appropriate dot pattern arrangement.

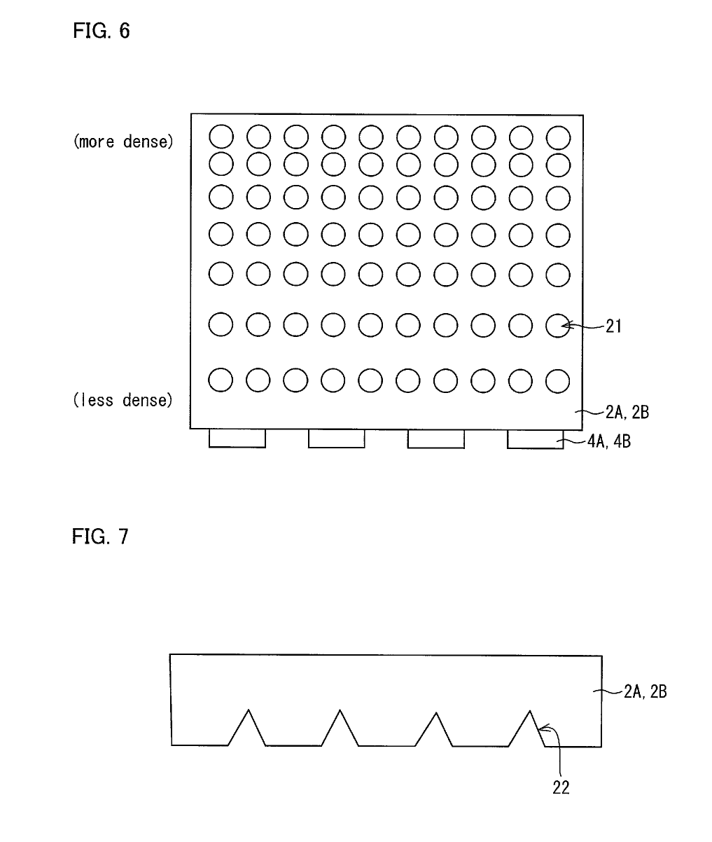

FIG. 6 is a plain view illustrating bottom surfaces of light guide plates 2A and 2B, which are dot-processed.

As illustrated in FIG. 6, a plurality of dots 21 are formed on the respective bottom surfaces of the light guide plates 2A and 2B. Here, the plurality of dots 21 are semi-spherical in shape, for example.

The bottom surface of the light guide plate 2A is configured such that the plurality of dots 21 are formed in such a way that density of dots 21 is increased along a direction from a side surface facing the light source 4A to a side surface (a side surface far from the light source 4A) opposite to the side surface.

Likewise, the bottom surface of the light guide plate 2B is configured such that the plurality of dots 21 are formed in such a way that density of dots 21 is increased along a direction from a side surface facing the light source 4B to a side surface (a side surface far from the light source 4A) opposite to the side surface.

With this configuration, it is possible to cause the light entering the light guide plate 2A from the light source 4A to be sequentially reflected by the plurality of dots 21 on the bottom surface of the light guide plate 2A before entering the optical path changing member 1.

Moreover, it is possible to cause the light entering the light guide plate 2B from the light source 4B to be sequentially reflected by the plurality of dots 21 on the bottom surface of the light guide plate 2B before entering the optical path changing member 1.

Consequently, it is possible to reduce the number of times the light entering from the light sources 4A and 4B to the light guide plates 2A and 2B are respectively reflected inside each of the light guide plates 2A and 2B, respectively. Therefore, it is possible to obtain a BL unit 20 in which the in-plane unevenness of the color is alleviated.

Moreover, the processing on the bottom surfaces of the light guide plates 2A and 2B are not limited to processing to form the semi-spherical dots 21, but may be processing to form prism shapes (triangular pyramids) whose cross-sectional shape is triangular as illustrated in FIG. 7.

FIG. 7 is a cross-sectional view of light guide plates 2A and 2B, whose bottom surfaces are processed to have prism shapes thereon.

In general, the formation of such convexoconcave shapes on the bottom surface SUF5A and 5B of the light guide plates 2A and 2B may be carried out, for example, by injection-molding process to perform injection molding with use of a mold for the convexoconcave shapes, or by pattern printing process to form a light guide member having a flat surface by injection molding or casting, and print special ink on the light guide member by screen printing, so that protrusions are formed on the light guide member.

In order to prepare a light guide plate having a small size and a small area, the injection-molding process is employed in general, because the injection molding process can give the light guide plate a shorter production time and a lower cost.

On the other hand, in order to form a light guide plate having a large size and a large surface, the pattern printing process, instead of the injection-molding, is employed in general, because of residual stress of the resin, or because the injection-molding process is not so cost effective in producing a large-sized light guide plate, compared with a small-sized light guide plate.

In case of the small-sized light guide plate, the convexoconcave pattern is formed in consideration of influence from light reflected on the side surface on the other side of (far from) the light source facing another side surface. Therefore, density balance of the convexoconcave shape pattern can be relatively uniform in plane.

On the other hand, in case of the large-sized light guide plate, the influence from the light reflected on the side surface on the other side of (far from) the light source facing another side surface is small. Therefore, the convexoconcave shape pattern is formed to have a density increasing with distance from the light source.

Thus, for example, if a light source is provided for each of facing side surfaces of a light guide plate and such a convexoconcave shape pattern that the convexoconcave shapes become more dense toward one of the light sources but less dense toward the other one of the light sources, this results in that light emitted in different directions from the light guide plate have different properties, thereby failing to attain in-plane uniformity when viewed askew.

On the other hand, the BL unit 20 includes the different light guide plates 2A and 2B, each of which can be individually optimized in terms of the density pattern of the convexoconcave shapes provided on their bottom surfaces. Therefore, the exit light A (FIG. 3) and the exit light B (FIG. 3) can be identical in property.

With this configuration, the backlight unit can be large-sized without the problem of color differences across the display panel in the plane view, thereby preventing display quality deterioration.

(Reflecting Plate 3)

As illustrated in FIG. 3, the reflecting plate 3 is a light reflecting member for reflecting light leaked from the bottom surface SUF5A of the light guide plate 2A. The reflecting plate 3 has a flat surface.

The reflecting plate 3 has a plate-like shape in the present embodiment, but not limited to this. The reflecting plate 3 may have various shape. Moreover, the reflecting plate 3 is a film of a polyester resin or polyolefin resin, or a white film. The white film is prepared by whitening a plastic resin by adding therein a pigment such as titanic oxide, barium sulfate, calcium carbonate, aluminum hydroxide, magnesium carbonate, aluminum oxide, or the like before forming the plastic resin into a film or sheet, and then forming the film or the sheet from the plastic resin. It is possible to add an inorganic filler such as calcium carbonate, titanic oxide, or the like into the resin, forming the film from the resin, and then further processing the film by extending the film and forming a large number of micro voids in the film.

(Light Sources 4A and 4B)

As illustrated in FIG. 3, the light source 4A is positioned to emit light to the light guide plate A from the B side. The light source 4B is positioned to emit light to the light guide plate B from the A side. That is, the light sources 4A and 4B are provided on the opposite sides as illustrated in FIG. 3, in which they are provided on left and right sides oppositely.

Moreover, the light of the light source 4A is emitted in a right direction (exit light A in FIG. 3), and the light of the light source 4B is emitted in a left direction (exit light B in FIG. 3)

With this configuration, it is possible to attain in-plane uniformity in luminance of the backlight, and lateral symmetry of light direction angle distribution of illumination.

Moreover, even though the light sources 4A and 4B are LEDs (light Emitting Diodes) in the present embodiment, the light sources 4A and 4B may be surface light source such as CCFT (Cold Cathode Fluorescent Tube) or an electroluminescence. The light sources are at least two independent LEDs herein. However, in case of the CCFT, the light sources 4A and 4B may be constituted by a single fluorescent tube having a U-like shape, so that the light sources 4A and 4B are continuous. Moreover, the light sources 4A and 4B may be a pair of L-shaped fluorescent tubes.

Moreover, the light sources 4A and 4B may be provided with a reflector (not illustrated). The reflector has a parabolic shape internally, and the light source 4A or 4B are provided at a focus part of the parabolic shape.

(Liquid Crystal Panel 5)

The Liquid crystal panel 5 is a display panel capable of performing multi-view display for a plurality of images. As illustrated in FIG. 3, the liquid crystal panel 5 has a light illumination surface SUF3 to which the light emitted from the light exit surface 4B of the light guide plate 2B is directly emitted.

The liquid crystal panel 5 includes, in the order from its front to back, a polarizing plate 51, a parallax barrier 52, a bonding layer 53, a CF (Color Filter) substrate 54, a TFT (Thin Film Transistor) substrate 55, and a polarizing plate 56. Moreover, the liquid crystal panel 5 includes a liquid crystal layer (not illustrated) between the CF substrate 54 and the TFT substrate 55.

Here, the liquid crystal panel 5 is configured such that a display region is backlighted on the A side (right side of FIG. 3) with the light emitted from the optical path changing member 1 receiving the light of the light source 4A via the light guide plates 2A and 2B. As a result, an image displayed on the display region on the A side has a luminance peak at a viewing angle 45°.

On the other hand, the liquid crystal panel 5 is configured such that a display region is backlighted on the B side (left side of FIG. 3) with the light emitted from the optical path changing member 1 receiving the light of the light source 4B via the light guide plate 2B. As a result, an image displayed on the display region on the B side has a luminance peak at a viewing angle −45°.

With this configuration, the luminance peak of the image displayed on the A side of the liquid crystal panel 5 and the luminance peak of the image displayed on the B side of the liquid crystal panel 5 are obtained in different directions.

Therefore, the display system 100 can display respective images on the A side and B side of the liquid crystal panel 5 with luminance peaks at desired viewing angles, thereby improving the display quality of the images, respectively.

(Polarizing Plates 51 and 56)

As illustrated in FIG. 3, the polarizing plates 51 and 56 each includes (i) a polarizer base material in which polarizing elements are present, (ii) base substrates (not illustrated) sandwiching the polarizer base material, (iii) a protective film on one side, and (iv) an exfoliate film (not illustrated) for bonding the polarizing plate to a glass substrate on the other side.

The polarizing plates 51 and 56 are so thin that their thickness in total will be approximately in a range of 0.12 mm to 0.4 mm even if laminated in about 10 layers. The polarizer base material in which the polarizing elements are present is such that the polarizing elements are iodine or dichroic dye, which causes a polarizing effect. The polarizer base material is polyvinyl alcohol (PVA, polyvinyle Alcohol). The polarizing elements are contained in the polarizer base material. The base substrate for protecting the polarizer base material is triacetyl cellulose, Cellulose triacetate). On one side of the exfoliate film, which side faces the base substrate, an adhesive layer is applied. In adhering the polarizing plate to a glass substrate, the exfoliate film is peeled off from the adhesive layer and the polarizing plate is adhered to the glass substrate via the adhesive layer.

(Parallax Barrier 52)

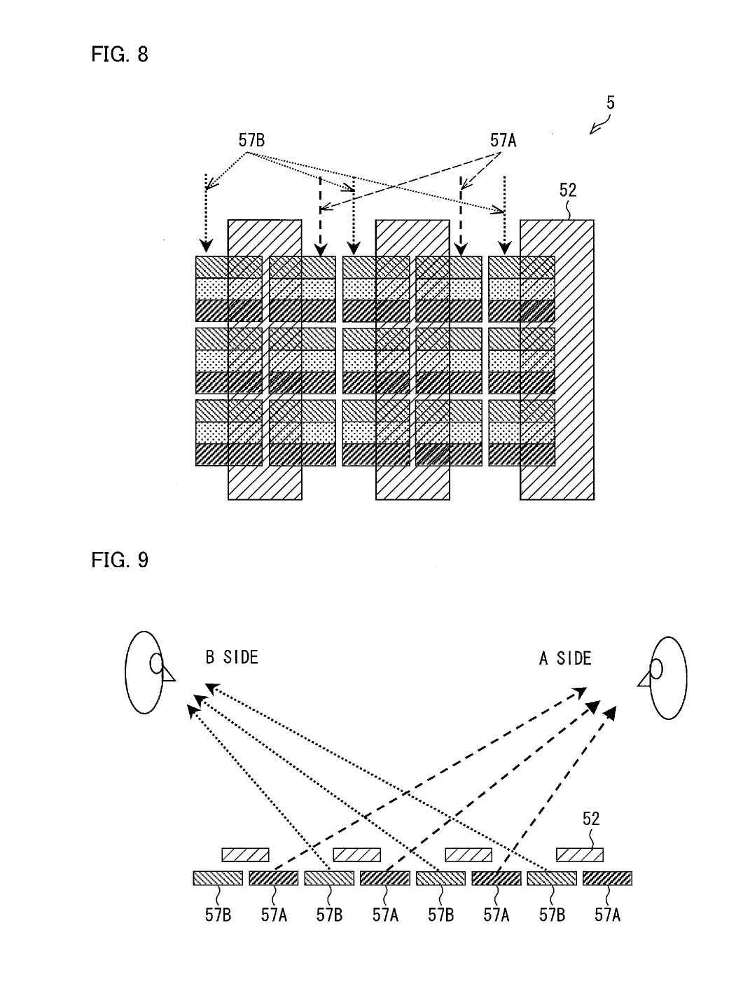

Next, referring to FIGS. 8 and 9, the parallax barrier 52 is discussed below.

The parallax barrier 52 is an optical member, in which light transmitting regions and light shielding regions are formed in stripes. By the parallax barrier 52, a plurality of images to be displayed is separated for corresponding display regions, individually.

FIG. 8 is a plan view illustrating the liquid crystal panel 5 to which the parallax barrier is provided. FIG. 9 is a view illustrating how the light is emitted to the A side and B side of the liquid crystal panel 5.

As illustrated in FIG. 8, for example, the parallax barrier 52 covers right-hand side of pixels of odd-numbered lines while covering left-hand side of pixels of even-numbed lines. Here, the pixels of the even-numbered lines are referred to as pixels 57A. The left-hand side of the pixels 57A are covered with the parallax barrier 52 while the right-hand side of the pixels 57A are exposed. The pixels of the odd-numbered lines are referred to as pixels 57B. The right-hand side of the pixels 57B are covered with the parallax barrier 52 while the left-hand side of the pixels 57B are exposed.

As illustrated in FIG. 9, the pixels 57A, whose left-hand side is covered with the parallax barrier 52, do not output an image to the B side (left-hand side) but mainly output an image to the A side (right-hand side). Meanwhile, the pixels 57B, whose right-hand side is covered with the parallax barrier 52, do not output an image to the A side (right-hand side) but mainly output an image to the B side (left-hand side).

With this configuration, for example, when a blue image is displayed on the pixels 57A and a red image is displayed on the pixels 57B, a user on the A side sees that the liquid crystal panel 5 displays the blue image on a whole screen thereof, while a user on the B side sees that the liquid crystal panel 5 displays the red image on a whole screen thereof.

With this configuration in which the parallax barrier covers the pixels by half, it is possible to display different images on the pixels 57A and 57B, respectively (DV display), so as to show the different images to the users on the A side and B side, respectively.

DV display can be performed in such a way that the parallax barrier 52 and the pixels are configured such that viewing angles for the A side and B side are ±45°. Moreover, 3 D display for naked eyes can be performed in such a way that the parallax barrier 52 and the pixels are configured such that viewing angles for the A side and B side are ±6°.

(Bonding Layer 53)

The boding layer 53 illustrated in FIG. 3 is a transparent resin layer (such as acrylic resin or the like) for bonding the parallax barrier 52 and the CF substrate 54. Because the parallax barrier 52 cannot function as a parallax barrier if the parallax barrier 52 and the CF substrate 54 are bonded in contact with each other, the bonding layer 53 provides an adequate distance between the parallax barrier 52 and the CF substrate 54. It is only required that the distance be sufficient for allowing DV display.

(CF Substrate 54)

The CF substrate 54 illustrated in FIG. 3 is configured such that a coloring layer for passing light in red (R), green (G), or blue (B) for the corresponding pixels, and a black matrix (BM) are provided on a substrate, and a protective film is provided on the coloring layer. The coloring layer is made from a coloring material applied in micropattern on the CF substrate 54, or from a coloring film. The coloring layer may be of a pigment type or a dye type. The BM layer is provided to prevent light leakage in black display, and color mixing between adjacent colors. The BM layer prevents photo-electric current caused due to light irradiation onto the TFT substrate 55.

In case where a photosensitive material is used to fix the coloring material, the photosensitive material is mixed in the coloring material, so that the coloring material can be fixed. To form a thin BM layer of approximately 0.1 μm, metal chrome is popular. Other than that, carbon, titanium, nickel, etc. are used to form a BM layer.

In gaps formed within the BM layer, each color of the coloring layer is formed in a predetermined pattern and the coloring layer has a thickness thicker than the BM layer by about 1.2 μm. For a high-resolution screen, the pattern of the color layer often has a stripe configuration. For a low-resolution screen, the pattern of the color layer favorably has a delta configuration for the sake of attaining good image quality impression.

(Sensors 6A and 6B)

As illustrated in FIG. 1, the sensors 6A and 6B are provided on a front side of the liquid crystal panel 5, that is, on that side of the liquid crystal panel 5 on which the liquid crystal panel 5 displays an image. The sensors 6A and 6B are provided within a frame 9 serving as a housing. The sensors 6A and 6B are luminance sensors for sensing luminance of light entering the sensors.

In the present embodiment, the sensor 6A is provided on an optical path of the light emitted from the display region on the left-hand side (B side) of the liquid crystal panel 5. The sensor 6A measures the luminance of the light entering the sensor 6A and provides a result of the measurement to the calculation section 7 as detection data A.

The sensor 6B is provided on an optical path of the light emitted from the display region on the right-hand side (A side) of the liquid crystal panel 5. The sensor 6B measures the luminance of the light entering the sensor 6B and provides a result of the measurement to the calculation section 7 as detection data B, which is the other detection data than the detection data A.

(Calculation Section 7)

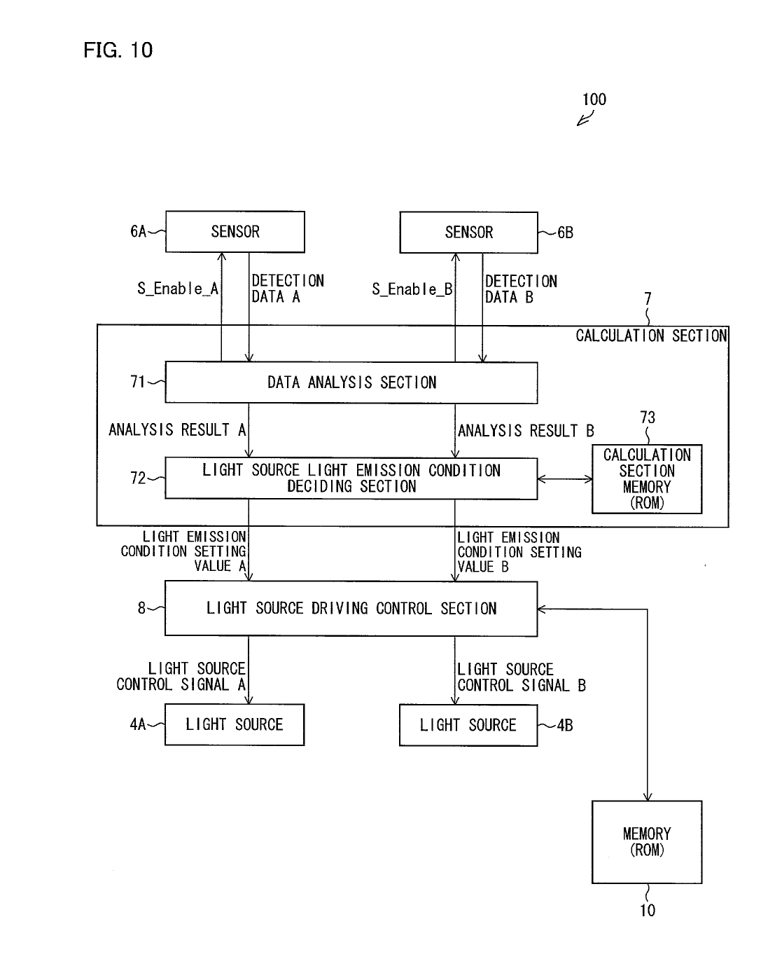

Next, referring to FIG. 10, the calculation section 7 is discussed below. FIG. 10 is a block diagram illustrating a configuration of the display system 100 provided with the calculation section 7.

As illustrated in FIG. 10, the calculation section 7 includes a data analyzing section 71, a light source light emission condition deciding section 72, and a calculation section memory 73.

In the following, operations of the calculation section and constituent elements relating to the calculation section 7 are discussed, referring to FIG. 10.

By way of example, the following discusses a case where the luminance of the light (the left-hand side image IL in FIG. 2) entering the sensor 6A is greater than that of the light (the right-hand side image IR in FIG. 2) entering the sensor 6B, as indicated by sizes of outline arrows in FIG. 1.

<Data Analysis Section 71>

The data analysis section 71 is configured to send a measurement command signal S_Enable_A to the sensor 6A. Moreover, the data analysis section 71 is configured to send a measurement command signal S_Enable_B to the sensor 6B.

The sensor 6A receives the measurement command signal S_Enable_A, and then starts the measurement of the luminance. The sensor 6A sends the result of the measurement to the data analysis section 71 as the detection data A. The sensor 6B receives the measurement command signal S_Enable_B, and then starts the measurement of the luminance. The sensor 6B sends the result of the measurement to the data analysis section 71 as the detection data B.

The data analysis section 71 receives the detection data A and B. The data analysis section 71 performs AD (Analog-Digital) conversion and denoising to the detection data A, thereby obtaining analysis result A. Then, the data analysis section 71 sends the analysis result A to the light source light emission condition deciding section 72. The data analysis section 71 also performs AD conversion and denoising to the detection data B, thereby obtaining analysis result B. Then, the data analysis section 71 sends the analysis result B to the light source light emission condition deciding section 72.

(Light Source Light Emission Condition Deciding Section 72)

The light source light emission condition deciding section 72 receives the analysis results A and B. The light source light emission condition deciding section 72 compares the luminance value measured by the sensor 6A and indicated by the analysis result A and the luminance value measured by the sensor 6B and indicated by the analysis result B, so as to find out which one is larger than the other. In this example, the luminance of the left-hand side image IL is higher than the luminance of the right-hand side image IR. Thus, the luminance value measured by the sensor 6A and indicated by the analysis result A is greater than the luminance value measured by the sensor 6B and indicated by the analysis result B.

Here, the calculation section memory 73 is, for example, a ROM (Read Only Memory). The calculation section memory 73 stores therein in advance a look-up table prescribing relationship between results of the comparison and whether to increase or decrease values of currents to be supplied to the light sources 4A and 4B.

The light source light emission condition deciding section 72 reads out the look-up table from the calculation section memory 73.

The look-up table has information for such a command that the current value of the current to be supplied to the light source 4A be decreased by a predetermined value, when the luminance value indicated by the analysis result A is greater than the luminance value indicated by the analysis result B. Moreover, the look-up table has information for such a command that the current value of the current to be supplied to the light source 4A be increased by a predetermined value, when the luminance value indicated by the analysis result A is smaller than the luminance value indicated by the analysis result B.

According to the information contained in the look-up table, the light source light emission deciding section 72 sends a light emission condition setting value A to the light source driving control section 8, the light emission condition setting value A decreasing or increasing by a predetermined value the current value of the current to be supplied to the light source 4A.

That is, when the luminance value indicated by the analysis result A is greater than the luminance value indicated by the analysis result B, the light emission condition setting value A is to command the light source driving control section 8 to decrease by a predetermined value the current value of the current to be supplied to the light source 4A. On the other hand, when the luminance value indicated by the analysis result A is smaller than the luminance value indicated by the analysis result B, the light emission condition setting value A is to command the light source driving control section 8 to increase by a predetermined value in the current value of the current to be supplied to the light source 4A.

In this example, because the luminance value indicated by the analysis result A is greater than the luminance value indicated by the analysis result B, the light emission condition setting value A is to command the light source driving control section 8 to cause a decrease of a predetermined value in the current value of the current to be supplied to the light source 4A.

On the contrary, the look-up table may be configured such that the look-up table has information for such a command that the current value of the current to be supplied to the light source 4B be increased by a predetermined value, when the luminance value indicated by the analysis result A is greater than the luminance value indicated by the analysis result B.

Further, the look-up table may be configured such that the look-up table has information for such a command that the current value of the current to be supplied to the light source 4B be decreased by a predetermined value, when the luminance value indicated by the analysis result A is smaller than the luminance value indicated by the analysis result B. In these cases, the light source light emission condition deciding section 72 sends a light emission condition setting value B to the light source driving control section 8, the light emission condition setting value B decreasing or increasing by a predetermined value the current value of the current to be supplied to the light source 4B, like the light emission condition setting value A decreasing or increasing by a predetermined value the current value of the current to be supplied to the light source 4A.

(Light Source Driving Control Section 8)

The light source driving control section 8 receives the light emission condition setting value A or B.

The light source driving control section 8 may be, for example, a general LED driving circuit for supplying a current to the light source 4A and 4B, thereby driving the light sources 4A and 4B.

Therefore, the light source driving control section 8 can easily generate a light source control signal A according to the light emission condition setting value A, the light source control signal A being the current to be supplied to the light source 4A. That is, in this example, the light source driving control section 8 decreases a current value of the light source control signal A according to the light emission condition setting value A.

Likewise, the light source driving control section 8 can easily generate a light source control signal B according to the light emission condition setting value B, the light source control signal B being the current to be supplied to the light source 4B. That is, in this example, the light source driving control section 8 increases a current value of the light source control signal B according to the light emission condition setting value B.

The operation as described above is repeated until a difference between the luminance value indicated by the analysis result A and the luminance value indicated by the analysis result B becomes less than a predetermined value (for example, the value by which the current value of the current to be supplied to the light source 4A or 4B is increased or decreased by a single current value adjusting operation). The difference between the luminance value indicated by the analysis result A (the luminance value measured by the sensor 6A) and the luminance value indicated by the analysis result B (luminance value measured by the sensor 6B) may be calculated out from the analysis results A and B by the light source light emission condition deciding section 72.

(PWM Control)

The driving control of the light sources 4A and 4B herein is current control in which amplitudes of the current to be supplied to the light sources 4A and 4b are variable.

Meanwhile, the driving control of the LED may be performed by, instead of the current control, PWM (Pulse Width Modulation) in which a pulse width of the current to be supplied to the light sources 4A and 4B is variable.

The display system 100 can attain a similar effect to the above-described driving control even if the driving control for the light sources 4A and 4B is performed by PWM. Thus, the PWM control is explained below.

In the following, operations of the calculation section 7 and the members relating to the calculation section 7 are explained only as to differences from the above-described operations.

The calculation section memory 73 stores therein in advance a look-up table prescribing a relationship between the results of the comparison between the luminance value indicated by the analysis result A and the luminance value indicated by the analysis result B, and width adjustment of a pulse width per cycle of the current to be supplied to the light sources 4A and 4B. Hereinafter, the “pulse width per cycle of the current” is referred to as “current pulse width”, simply.

The light source light emission condition deciding section 72 reads out the look-up table from the calculation section memory 73.

The look-up table has information for such a command that the pulse width of the current to be supplied to the light source 4A be shortened by a predetermined value, because the luminance value indicated by the analysis result A is greater than the luminance value indicated by the analysis result B. Moreover, the look-up table has information for such a command that the pulse width of the current to be supplied to the light source 4A be prolonged by a predetermined value, because the luminance value indicated by the analysis result A is smaller than the luminance value indicated by the analysis result B.

According to the information contained in the look-up table, the light source light emission deciding section 72 sends a light emission condition setting value A to the light source driving control section 8, the light emission condition setting value A shortening or prolonging, by a predetermined value, the pulse width of the current to be supplied to the light source 4A.

That is, when the luminance value indicated by the analysis result A is greater than the luminance value indicated by the analysis result B, the light emission condition setting value A is to command the light source driving control section 8 to shorten by a predetermined value the pulse width of the current to be supplied to the light source 4A. On the other hand, when the luminance value indicated by the analysis result A is smaller than the luminance value indicated by the analysis result B, the light emission condition setting value A is to command the light source driving control section 8 to prolong by a predetermined value the pulse width of the current to be supplied to the light source 4A.

On the contrary, the look-up table may be configured such that the look-up table has information for such a command that the pulse width of the current to be supplied to the light source 4B be prolonged by a predetermined value, when the luminance value indicated by the analysis result A is greater than the luminance value indicated by the analysis result B.

Further, the look-up table may be configured such that the look-up table has information for such a command that the pulse width of the current to be supplied to the light source 4B be shortened by a predetermined value, when the luminance value indicated by the analysis result A is smaller than the luminance value indicated by the analysis result B. In these cases, the light source light emission condition deciding section 72 sends a light emission condition setting value B to the light source driving control section 8, the light emission condition setting value B shortening or prolonging by a predetermined value the pulse width of the current to be supplied to the light source 4B, like the light emission condition setting value A shortening or prolonging by a predetermined value the pulse width of the current to be supplied to the light source 4A.

The light source driving control section 8 receives the light emission condition setting value A or B.

The light source driving control section 8 may be, for example, a general LED driving circuit for supplying a PWM-modified current to the light source 4A and 4B, thereby driving the light sources 4A and 4B.

Therefore, the light source driving control section 8 can easily generate a light source control signal A according to the light emission condition setting value A, the light source control signal A being the current to be applied to the light source 4A. That is, in this example, the light source driving control section 8 shortens or prolongs a pulse width of the light source control signal A according to the light emission condition setting value A.

Likewise, the light source driving control section 8 can easily generate a light source control signal B according to the light emission condition setting value B, the light source control signal B being the current to be applied to the light source 4B. That is, in this example, the light source driving control section 8 shortens or prolongs a pulse width of the light source control signal B according to the light emission condition setting value B.

The operation as described above is repeated until a difference between the luminance value indicated by the analysis result A and the luminance value indicated by the analysis result B becomes less than a predetermined value (for example, the value by which the pulse width of the current to be supplied to the light source 4A or 4B is shortened or prolonged by a single operation). The difference between the luminance value indicated by the analysis result A (the luminance value measured by the sensor 6A) and the luminance value indicated by the analysis result B (luminance value measured by the sensor 6B) may be calculated out from the analysis results A and B by the light source light emission condition deciding section 72.

These configurations make it possible to attain substantially uniform luminance as a whole when the luminance of the image to be displayed on the A side of the liquid crystal panel 5 and the luminance of the image to be displayed on the B side of the liquid crystal panel 5 are different from each other due to differences between the individual light sources 4A and 4B, asymmetric viewing characteristics of the liquid crystal panel 5, and mispositioning of the parallax barrier 52, or the like cause. That is, the display system 100 can attain the aforementioned effect also in case where the driving control of the light sources 4A and 4BB are performed by PWM.

(Memory 10)

Furthermore, the light source driving control section 8 may be configured to read out information stored in the memory 10 and write information on the memory 10.

This configuration makes it possible to (i) record, in the memory 10, information regarding current values of the currents supplied to the light sources 4A and 4B at an end of operation, (ii) read out, from the memory 10, a current value that the light source control signal A has according to the light emission condition setting value A, and (iii) read out from the memory 10 a current value that the light source control signal B has according to the light emission condition setting value B.

The memory 10 may be provided inside the backlight section 300 or inside the other part of the display device section 200 (see FIG. 2).

This configuration makes it possible to attain substantially uniform luminance as a whole when the luminance of the image to be displayed on the A side of the liquid crystal panel 5 and the luminance of the image to be displayed on the B side of the liquid crystal panel 5 are different from each other due to differences between the individual light sources 4A and 4B, asymmetric viewing characteristics of the liquid crystal panel 5, and mispositioning of the parallax barrier 52, or the like cause.

(Another Embodiment of BL Unit)

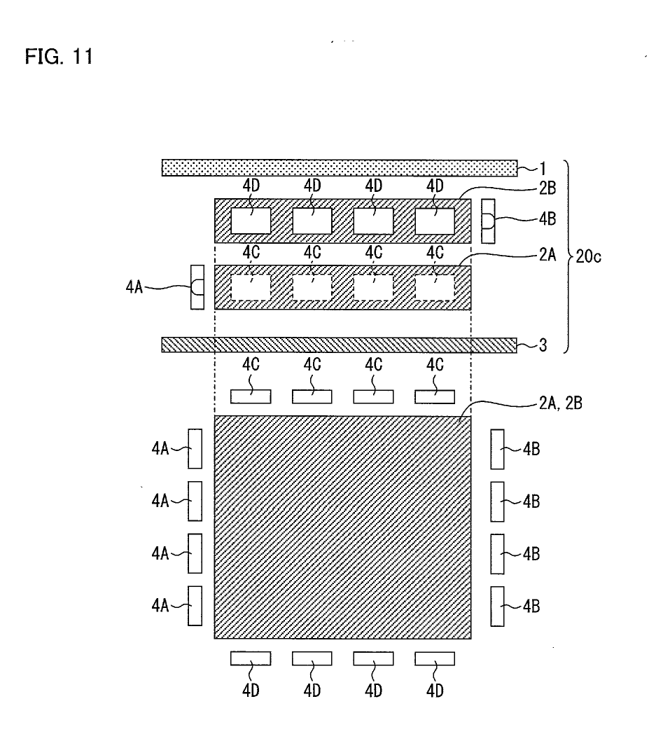

Next, another embodiment of a BL unit is described below, referring to FIG. 11. FIG. 11 is a view illustrating a BL unit (backlight unit) 20c, which is still another exemplary embodiment of the backlight unit.

The BL unit 20c is different from the BL unit 20 in that the light sources are not provided along each of two edges (side surfaces) of the light guide plates 2A and 2B, respectively.

The BL unit 20c is configured such that the light sources 4A and 4C (4 each) are provided along respective two adjacent edges of the light guide plate 2A, and no light sources are provided along the other edges facing either of the two adjacent edges along which the light sources 4A or the light sources 4C (first light sources, second light sources) are provided.

The BL unit 20c is also configured such that the light sources 4B and 4D (4 each) are provided along respective two adjacent edges of the light guide plate 2B, and no light sources are provided along the other edges facing either of the two adjacent edges along which the light sources 4B or the light sources 4D (first light sources, second light sources) are provided.

In this way, the light sources 4A, 4B, 4C, and 4D are provided along the respective 4 edges (side surfaces) of the BL unit 20c in its plane view.

With the BL unit 20c, it is possible to realize a backlight suitable for CV display in which different images are displayed for 4 directions, namely upwards, downwards, rightwards and leftwards.

An optical path changing member 1 of the BL unit 20C is preferably a diffusion sheet 1a in which the optical property (Φ<θ) is not directionally dependent, or a diffusion sheet 1a which has the optical property (Φ<θ) at least in a direction from the left to right (or right to left) and in a direction from top to bottom (or bottom to top) in its plane view.

[Additional Description]

The present invention is not limited to the description of the embodiments above, and can therefore be modified by a skilled person in the art within the scope of the claims. Namely, an embodiment derived from a proper combination of technical means disclosed in different embodiments is encompassed in the technical scope of the present invention.

As described above, in order to attain the object, a backlight unit according to the present invention comprises: light sources; light guide members, the light sources including a first light source and a second light source, and the light guide members including a first light guide member and a second light guide member, the first light source being provided to a side surface of the first light guide member, the second light source being provided to a side surface of the second light guide member, the first and second light sources being provided across the first and the second light guide members in plane view; and an optical path changing member for changing an optical path of light passing through the optical path changing member, the optical path changing member having a light incidence surface for receiving light emitted directly from the first or second light guide member, and a light exit surface for emitting, directly to a display panel outside of the backlight unit, the light thus received via the light incidence surface.

In the above configuration, the backlight unit includes the first and second light sources provided across the first and second light guide members in the plane view, the first light guide member provided with the first light source being provided to the side surface of the first light guide member, the second light guide member provided with the second light source being provided to the side surface of the second light guide member, and the optical path changing member for changing the optical path of the light passing through the optical path changing member.

This configuration makes it possible to emit, from the light exit surface of the optical path changing member, light having luminance directivity whose luminance distribution is maximum in at least two directions different from a normal direction of the display screen of the display panel.

Furthermore, because the first and second light sources are positioned across the first and second light guides, the backlight unit can be large-sized without the problem of color differences across the display panel in the plane view, thereby preventing display quality deterioration.

Moreover, it is preferable that the first and second light guide members overlap each other in plane view. With this configuration, the backlight unit can illuminate a large-sized display panel, while the backlight unit itself can have a smaller surface.

Furthermore, it is preferable that the first and second light guide members have a back surface on which a plurality of convexoconcave shapes are formed, the plurality of convexoconcave shapes on the back surface of the first light guide member having a density being less dense toward that side surface of the first light guide member to which the first light source is provided, and being more dense toward that another side surface of the first light guide member which faces the side surface, and the plurality of convexoconcave shapes on the back surface of the second light guide member having a density being less dense toward that side surface of the second light guide member to which the second light source is provided, and being more dense toward that another side surface of the second light guide member which faces the side surface.

With this configuration, the light entering from the first light source into the first light guide member can be entered into the optical path changing member after sequentially reflected by the convexoconcave shapes provided on the back surface of the first light guide, and while the light entering from the second light source into the second light guide member can be entered into the optical path changing member after sequentially reflected by the convexoconcave shapes provided on the back surface of the second light guide member.

With this configuration, the number of time the light is reflected inside the first and second light guide members can be reduced, thereby making it possible to attain a backlight unit in which the in-plane color unevenness is alleviated.

Moreover, the plurality of convexoconcave shapes may be semi-spherical in shape or triangular pyramidal in shape. The backlight unit with the plurality of convexoconcave shapes may be embodied as such.

It is preferable that the light exit surface of the optical path changing member has a plurality of prisms arranged in rows, each row of the prisms being perpendicular to directions in which the first and the second light sources emit light.

With this configuration, the light entering the optical path changing member at a predetermined incident angle along the light exit directions of the first and second light sources is emitted at an exit angle from the exit surface, the exit angle being smaller than the light incident angle. Therefore, it is possible to attain a backlight unit having luminance directivity in different directions.

Moreover, it is preferable that the optical path changing member contains scattering micro particles for scattering light.

According to the configuration, it is possible to obtain desired total light transmittance and Haze by appropriately selecting (i) a base material, (ii) a material for the light scattering fine particles, (iii) an average particle diameter of the light scattering fine particles and/or (iv) a mixture ratio of the light scattering fine particles.

For example, in a case where the optical path changing member uniformly contains the light scattering fine particles, it can be said that the optical path changing member isotropically has the optical property though the optical property does not depend on direction.

Therefore, in this case, it is possible to realize a backlight unit suitable for, for example, so-called quartet view display (hereinafter referred to as “CV display”).

Furthermore, a display device according to the present invention is preferably configured to comprise: the aforementioned backlight unit; and the display panel for displaying information on a display screen of the display panel by receiving the light emitted from the light exit surface of the optical path changing member of the backlight unit.

With this configuration, it becomes possible to large-size a backlight unit without the fear of display quality deterioration, and to make it possible for such a backlight unit to emit light with luminance directivity in different directions.

Moreover, it is preferable that the display device comprises at least two luminance sensors which are provided in the respective at least two directions other than the direction normal to the display screen of the display panel, the at least two luminance sensors each detecting luminance of light emitted from the display screen; and a light source driving control section for adjusting a current to be supplied to the at least two light sources so that a difference between the luminances detected by the at least two luminance sensors is smaller than a predetermined luminance difference.

With this configuration, the light source driving control section is provided for adjusting a current to be supplied to the at least two light sources so that a difference between the luminances detected by the at least two luminance sensors is smaller than a predetermined luminance difference. Thus, it is possible to alleviate the in-plane unevenness in the luminances due to the differences between the first and the second light sources.

### INDUSTRIAL APPLICABILITY

The present invention is applicable to a backlight unit or a display device requiring such a backlight unit.

### REFERENCE SIGNS LIST

1: optical path changing member
1a: light diffusing sheet (optical path changing member)
1b: lens sheet (optical path changing member)
1c: prism
2A: light guide plate (first light guide, second light guide)
2B: light guide plate (second light guide, first light guide)
4A: light source (first light source, second light source)
4B: light source (second light source, first light source)
4C: light source (first light source, second light source)
4D: light source (second light source, first light source)
5: liquid crystal panel (display panel)
6A and 6B: sensor (luminance sensor)
7: calculation section
8: light source driving control section
20: BL unit (backlight unit)
20c: BL unit (backlight unit)
21: dots (convexoconcave shapes)
100: display system (display device)
SUF1: incidence surface (light receiving surface)
SUF2: light exit surface (light exit surface)
SUF4A: light exit surface
SUF4B: light exit surface
SUF5A: bottom surface
SUF5B: bottom surface

1. A backlight unit comprising:
light sources;
light guide members,
the light sources including a first light source and a second light source, and the light guide members including a first light guide member and a second light guide member,
the first light source being provided to a side surface of the first light guide member,
the second light source being provided to a side surface of the second light guide member,
the first and second light sources being provided across the first and the second light guide members in plane view; and
an optical path changing member for changing an optical path of light passing through the optical path changing member, the optical path changing member having a light incidence surface for receiving light emitted directly from the first or second light guide member, and a light exit surface for emitting, directly to a display panel outside of the backlight unit, the light thus received via the light incidence surface.

2. The backlight unit as set forth in claim 1, wherein the first and second light guide members overlap each other in plane view.

3. The backlight unit as set forth in claim 1, wherein
the first and second light guide members have a back surface on which a plurality of convexoconcave shapes are formed,
the plurality of convexoconcave shapes on the back surface of the first light guide member having a density being less dense toward that side surface of the first light guide member to which the first light source is provided, and being more dense toward that another side surface of the first light guide member which faces the side surface, and
the plurality of convexoconcave shapes on the back surface of the second light guide member having a density being less dense toward that side surface of the second light guide member to which the second light source is provided, and being more dense toward that another side surface of the second light guide member which faces the side surface.

4. The backlight unit as set forth in claim 3, wherein the plurality of convexoconcave shapes are semi-spherical in shape.

5. The backlight unit as set forth in claim 3, wherein the plurality of convexoconcave shapes are triangular pyramidal in shape.

6. The backlight unit as set forth in claim 1, wherein the light exit surface of the optical path changing member has a plurality of prisms arranged in rows, each row of the prisms being perpendicular to directions in which the first and the second light sources emit light.

7. The backlight unit as set forth in claim 1, wherein the optical path changing member contains scattering micro particles for scattering light.

8. A display device, comprising:
a backlight unit as set forth in claim 1; and
the display panel for displaying information on a display screen of the display panel by receiving the light emitted from the light exit surface of the optical path changing member of the backlight unit.

9. (canceled)

10. The display device as set forth in claim 8, wherein the display panel is configured to display different images in at least two directions different from a normal direction of the display screen, respectively.

11. The display device as set forth in claim 10, wherein the display panel comprises a liquid crystal panel and a parallax barrier.

12. The display device as set forth in claim 11, comprising:
at least two luminance sensors which are provided in each optical path of light emitted in the at least two directions by the display panel display for displaying the different images in the at least two directions, the at least two luminance sensors each detecting luminance of the light emitted from the display screen; and
a light source driving control section for adjusting a current to be supplied to the at least two light sources so that a difference between the luminances detected by the at least two luminance sensors is smaller than a predetermined luminance difference.
